(19) United States
(12) Patent Application Publication
(10) Pub. No.: US 2014/0125189 A1
(43) Pub. Date: May 8, 2014

(54) 3-PHASE PERMANENT MAGNET MOTOR OR GENERATOR HAVING VARIABLE STATOR TEETH

(71) Applicant: NIDEC MOTOR CORPORATION, St. Louis, MO (US)

(72) Inventor: Keith I. Hoemann, Fenton, MO (US)

(73) Assignee: NIDEC MOTOR CORPORATION, St. Louis, MO (US)

(21) Appl. No.: 14/073,682

(22) Filed: Nov. 6, 2013

Related U.S. Application Data
(60) Provisional application No. 61/723,248, filed on Nov. 6, 2012.

(51) Int. Cl. H02K 3/46

(52) U.S. Cl. CPC H02K 3/46
USPC 310/208

(57) ABSTRACT

An electric motor or generator machine is provided. The machine includes a rotor rotatable about an axis, as well as a stator. The stator includes a stator core and wiring wound around the stator core. The stator core includes a plurality of arcuately spaced apart alternating primary teeth and secondary teeth, such that each secondary tooth is spaced between a corresponding pair of primary teeth. The wiring is wound about the primary teeth to form a plurality of coils. The plurality of coils includes an A-phase coil, a B-phase coil, and a C-phase coil. Each of the primary teeth includes a generally radially extending primary arm and a generally arcuately extending primary crown. Each of the primary crowns spans one hundred sixty (160) to two hundred (200) electrical degrees.

### CROSS-REFERENCE TO RELATED APPLICATIONS

This application claims the benefit of U.S. Provisional Application No. 61/723,248, filed Nov. 6, 2012, which is incorporated herein by reference in its entirety.

### BACKGROUND OF THE INVENTION

1. Field of the Invention

The present invention relates generally to electric motors and generators. More particularly, the present invention concerns a motor or generator including a stator core having a plurality of arcuately spaced apart teeth, wherein the teeth include both primary teeth and secondary teeth.

2. Discussion of the Prior Art

Those of ordinary skill in the art will appreciate that electric motors or generators are often used in home appliances such dishwashers or washing machines, in vehicles such as golf carts, and in exercise equipment such as stationary bicycles. Such electric motors or generators often include a rotor and a stator, wherein the stator includes plurality of arcuately spaced apart teeth and wire wound around the teeth.

Although a variety of approaches to achieving high motor or generator efficiency are known in the art, such approaches often are complex and/or associated with increased costs. Similarly, techniques for reducing cogging torques may also be complex and/or expensive. A need therefore exists for a low cost electric motor or generator capable of meeting high efficiency requirements and low cogging torque requirements.

### SUMMARY

According to one aspect of the present invention, an electric motor or generator machine is provided. The machine comprises a rotor rotatable about an axis, as well as a stator. The stator includes a stator core and wiring wound around the stator core. The stator core includes a plurality of arcuately spaced apart alternating primary teeth and secondary teeth, such that each secondary tooth is spaced between a corresponding pair of primary teeth. The wiring is wound about the primary teeth to form a plurality of coils. The plurality of coils includes an A-phase coil, a B-phase coil, and a C-phase coil. Each of the primary teeth includes a generally radially extending primary arm and a generally arcuately extending primary crown. Each of the primary crowns spans one hundred sixty (160) to two hundred (200) electrical degrees.

This summary is provided to introduce a selection of concepts in a simplified form. These concepts are further described below in the detailed description of the preferred embodiments. This summary is not intended to identify key features or essential features of the claimed subject matter, nor is it intended to be used to limit the scope of the claimed subject matter.

Various other aspects and advantages of the present invention will be apparent from the following detailed description of the preferred embodiments and the accompanying drawing figures.

### BRIEF DESCRIPTION OF THE DRAWING FIGURES

Preferred embodiments of the present invention are described in detail below with reference to the attached drawing figures, wherein:

FIG. 1 is a bottom isometric view of an electric motor or generator constructed in accordance with the principles of a preferred embodiment of the present invention;

FIG. 2 is a top, partial cutaway isometric view of the electric motor or generator of FIG. 1, particularly illustrating the relative positioning of the rotor and the stator;

FIG. 3 is a top view of the stator core of FIG. 2 with schematic wiring, particularly illustrating the primary teeth, the secondary teeth, and the wiring pattern;

FIG. 4 is a top view of the stator core of FIGS. 2 and 3 and a portion of the rotor of FIGS. 1 and 2, particularly illustrating the preferred dimensions of the primary and secondary teeth of the stator core and the relationship between the stator core and the rotor;

FIG. 5 is a top view of the core and magnets of the rotor of FIGS. 2 and 4;

FIG. 6 is a top view of the core and magnets of a second preferred rotor embodiment; and

FIG. 7 is a top view of the core and magnets of a third preferred rotor embodiment.

The drawing figures do not limit the present invention to the specific embodiments disclosed and described herein. The drawings are not necessarily to scale, emphasis instead being placed upon clearly illustrating the principles of the preferred embodiments.

### DETAILED DESCRIPTION OF THE PREFERRED EMBODIMENTS

The present invention is susceptible of embodiment in many different forms. While the drawings illustrate, and the specification describes, certain preferred embodiments of the invention, it is to be understood that such disclosure is by way of example only. There is no intent to limit the principles of the present invention to the particular disclosed embodiments.

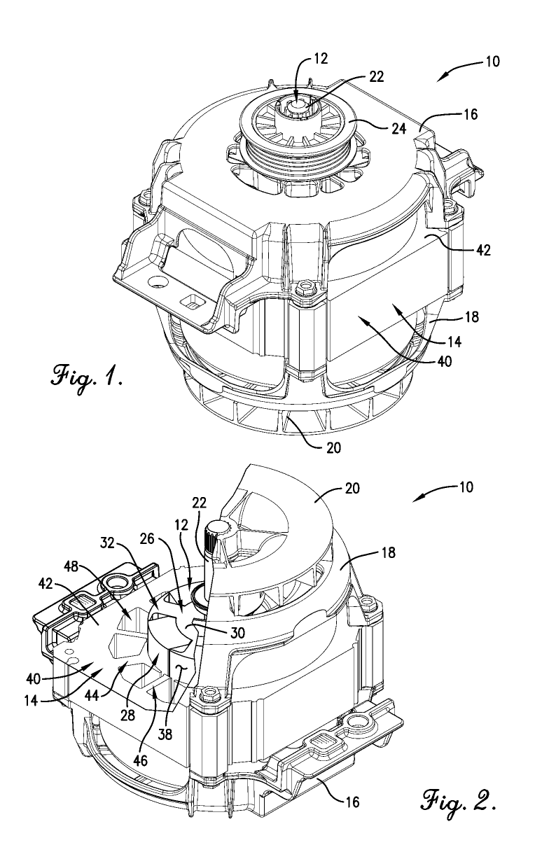

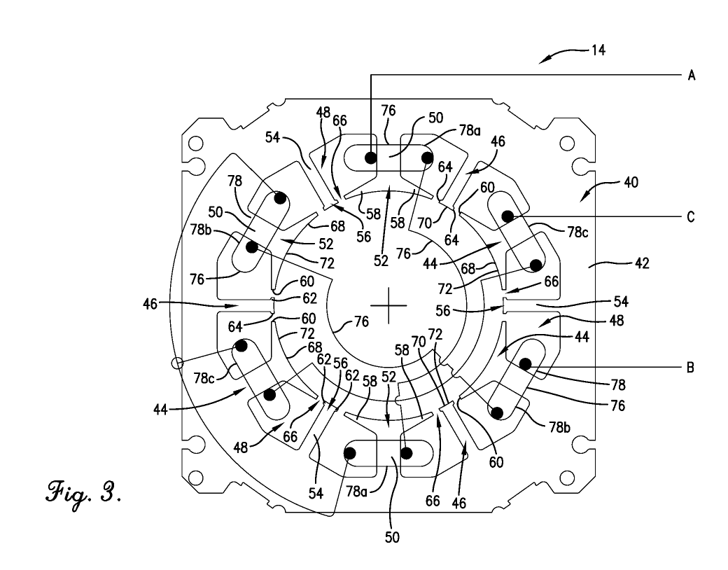

Turning initially to FIGS. 1 and 2, an electric motor or generator 10 is provided for use in a machine. The machine may be any one of a variety of types of machine, including but not limited to dishwashers; vertical- or horizontal-axis washing machines, including belt-driven washing machines; fans; vehicles such as golf carts and motorized bikes and scooters; and exercise equipment such as exercise bicycles.

The motor or generator 10 is preferably a variable-speed motor or generator and is preferably capable of reversing direction. However, a non-reversible and/or fixed speed motor or generator may be provided without departing from the scope of the present invention. Furthermore, the motor or generator 10 is preferably a brushless permanent magnet motor (BPM) or a brushless permanent magnet generator, although other motor or generator types may be used without departing from the scope of the present invention.

Preferably, the motor or generator 10 includes a rotor 12 that is rotatable about an axis, as well as stator 14. The rotor 12 and the stator 14 will be described in greater detail below.

The motor or generator 10 further preferably includes a pair of endshields 16 and 18 fixed to the stator 14 and configured to support the motor or generator 10 in the machine. Yet further, a fan element 20 configured to rotate with a rotor shaft 22 is preferably provided. A sheave 24 is configured for interconnection with a drive element such as a belt (not shown), such that rotor 12 rotation corresponds with driving movement of the fan element 20. Details of preferred embodiments of the endshields 16 and 18, the fan element 20, and the sheave 24 are provided by U.S. Pat. No. 8,278,793, filed Nov. 13, 2009, which is incorporated herein by reference in its entirety. However, a variety of motor or generator configurations, including those that omit or alter one or more of the endshields, sheave, and fan element as described above, fall within the ambit of the present invention.

In a preferred embodiment, the rotor 12 preferably includes a rotor core 26, a plurality of arcuately spaced apart magnets 28, and the shaft 22.

In a preferred embodiment, the rotor core 26 is a laminated core comprising a plurality of overlaid laminations. However, a non-laminated (e.g., solid) core is permissible according to some aspects of the present invention. Yet further, a segmented rotor core might be provided without departing from the scope of some aspects of the present invention.

The rotor core 26 preferably comprises steel, although any one or more of a variety of materials may be used without departing from the scope of the present invention.

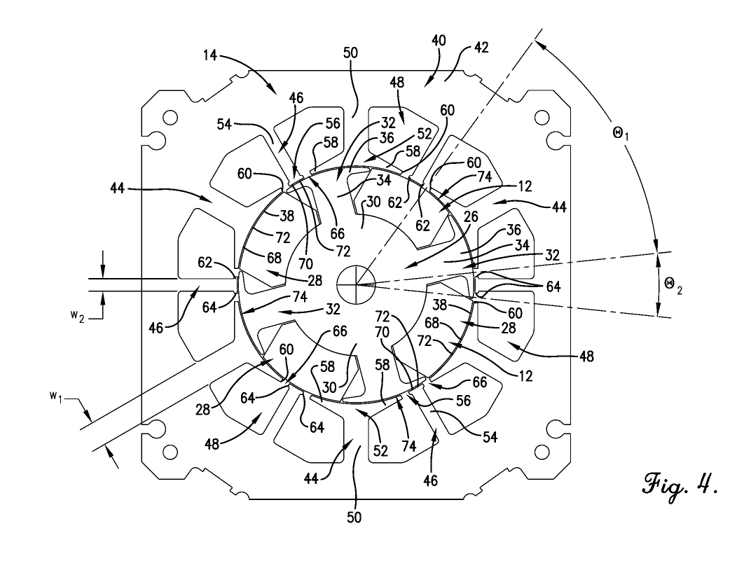

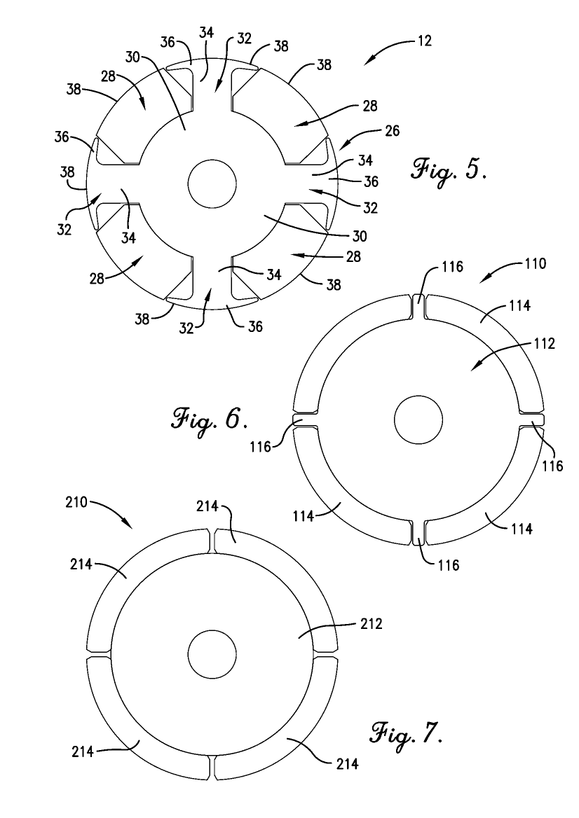

As best shown in FIGS. 4 and 5, the rotor core 26 preferably includes a rotor yoke 30 and a plurality of arcuately spaced apart rotor teeth 32 extending generally radially from the rotor yoke 30. Preferably, the rotor teeth 32 extend generally radially outwardly from the rotor yoke 30, although generally radially inwardly extending rotor teeth are permissible according to some aspects of the present invention.

Preferably, each of the rotor teeth 32 includes a generally radially extending rotor tooth arm 34 and a generally arcuately extending rotor tooth crown 36.

The rotor tooth crowns 36 preferably cooperatively in part define a radial margin 38 of the rotor 12. Preferably, the radial margin 38 is a radially outermost margin, with the stator 14 at least substantially circumscribing the rotor 12 and the motor or generator 10 thereby being an inner rotor motor or generator. It is permissible according to some aspects of the present invention, however, for an outer rotor to be used, with the rotor tooth crowns at least in part defining an inner margin of the rotor and with the rotor at least substantially circumscribing the stator such that the motor or generator is an outer rotor motor or generator.

The magnets 28 are preferably permanent magnets. More particularly, the magnets 28 are preferably permanent Grade 6 ferrite magnets, although other grades and/or materials may be used without departing from the scope of the present invention.

As best shown in FIGS. 4 and 5, the magnets 28 of the preferred rotor 12 are preferably surface magnets. More particularly, the magnets 28 are preferably alternately arcuately arranged with the rotor teeth 32 and cooperate with the rotor teeth 32 to define the radial margin 38 of the rotor 12. The rotor 12 is thus preferably a consequent pole, surface magnet rotor. It is permissible according to some aspects of the present invention, however, for the rotor to include embedded magnets and/or to utilize other magnet configurations.

Preferably, the radial margin 38 of the rotor 12 is at least substantially cylindrical, although other shapes are permissible within the scope of some aspects of the present invention.

In a preferred embodiment, the magnets 28 define pole pairs having generally radially oriented polarities. That is, the north pole and the south pole of each pole pair are radially spaced apart and generally arcuately aligned. It is permissible according to some aspects of the present invention, however, for the polarities to be skewed or otherwise alternatively oriented.

Each pole pair may be associated with a discrete piece of magnetizable material, or multiple poles might be formed in a given piece of material.

A portion of a second preferred rotor embodiment is shown in FIG. 6. More particularly, the rotor 110 of FIG. 6 includes a rotor core 112 and a plurality of arcuately spaced apart magnets 114. The rotor core 112 includes a plurality of arcuately spaced apart, generally radially extending sensing tabs 116 each of which extends between a corresponding pair of the magnets 114.

A portion of a third preferred rotor embodiment is shown in FIG. 7. More particularly, the rotor 210 of FIG. 7 includes a rotor core 212 and plurality of arcuately spaced apart magnets 214. However, no rotor teeth or sensing tabs are included.

As will be readily understood by one of ordinary skill in the art, certain features of the three preferred rotor embodiments may be combined to create additional suitable rotor embodiments.

As best shown in FIGS. 3 and 4, the stator 14 preferably includes a stator core 40 including a stator yoke 42, a plurality of arcuately spaced apart primary teeth 44, and a plurality of arcuately spaced apart secondary teeth 46. The stator yoke 42 preferably provides structural stability to the stator core 40; and the primary and secondary teeth 44 and 46, respectively, preferably extend at least substantially radially from the stator yoke 42.

The stator core 40 is preferably a laminated structure comprising steel. More particularly, the stator core 40 preferably comprises steel laminations that are similarly constructed and each preferably have a thickness of about 0.031 in. (0.79 mm). Furthermore, the preferred laminations are S85H5 steel laminations. However, other materials and/or thicknesses may be used, and the core could be a non-laminated (e.g., solid) structure. It is also permissible according to some aspects of the present invention for a segmented stator core to be provided.

Preferably, the primary teeth 44 and the secondary teeth 46 are alternately arranged such that each primary tooth 44 is positioned circumferentially between a pair of secondary teeth 46, and vice versa. A slot 48 is preferably defined between each adjacent pair of primary and secondary teeth 44 and 46, respectively.

In a preferred embodiment, each of the primary teeth 44 includes a primary tooth arm 50 and a primary tooth crown 52 extending at least substantially circumferentially from the primary tooth arm 50. Similarly, each of the secondary teeth 46 preferably includes a secondary tooth arm 54 and a secondary tooth crown 56 extending at least substantially circumferentially from the secondary tooth arm 54.

Preferably, each of the primary tooth crowns 52 extends from a radial end of a respective one of the primary teeth 44, while each secondary tooth crown 56 extends from a radial end of a respective one of the secondary teeth 46. Extension from an intermediate position along a respective arm is permissible according to some aspects of the present invention, however.

The arms 50 and 54 preferably extend radially inwardly from the stator yoke 42, with the crowns 52 and 56 extending from the radially inward ends of the respective arms 50 and 54. The stator 14 thus preferably at least substantially circumscribes the rotor 12, with the crowns 52 and 56 being positioned adjacent the rotor 12. Again, the rotor or generator may alternatively have an outer rotor configuration, in which the stator teeth extend radially outward from the stator yoke, with each crown being located adjacent the radially outer end of the corresponding stator tooth.

Each primary tooth crown 52 preferably includes a pair of primary tooth crown sections 58 that project in generally opposite, generally arcuate directions from an end of the corresponding primary tooth arm 50. Furthermore, each primary tooth crown 52 preferably defines a pair of circumferentially opposed primary tooth crown tips 60, each of which is formed at an arcuate end of one of the associated primary tooth crown sections 58.

Likewise, each secondary tooth crown 56 preferably includes a pair of secondary tooth crown sections 62 that project in generally opposite, generally arcuate directions from an end of the corresponding secondary tooth arm 54. Furthermore, each secondary tooth crown 56 preferably defines a pair of circumferentially opposed secondary tooth crown tips 64, each of which is formed at an arcuate end of one of the associated secondary tooth crown sections 62.

A crown gap 66 is preferably defined between each adjacent pair of primary and secondary crown tips 60 and 64, respectively. Preferably, the crown gaps 66 are at least substantially equal, although variations in crown gap size fall within the ambit of some aspects of the present invention.

Each secondary tooth crown 56 preferably serves as a connection structure for one or more additional components of the motor or generator, such as an insulating structure (not shown). It is permissible, however, for one or more of the secondary teeth to be devoid of crowns or for the secondary tooth crowns to not function as connection structure.

In a preferred embodiment, as illustrated, each of the primary and secondary teeth 44 and 46, respectively, is at least substantially symmetrical about respective radially extending axes. It is permissible according to some aspects of the present invention, however, for some or all of the teeth to be non-symmetrical. For instance, one tip of the crown of each secondary tooth might include special connection structure not found on the other tip.

Each of the primary teeth 44 preferably defines a primary tooth radially innermost surface 68, while each of the secondary teeth 46 preferably defines a secondary tooth radially innermost surface 70. The primary and secondary tooth radially innermost surfaces 68 and 70, respectively, preferably at least substantially cooperatively define a generally smooth, discontinuous cylindrical inner surface 72 of the stator core 40. However, it is permissible within the scope of some aspects of the present invention for a non-cylindrical surface to be defined by the innermost surfaces of the primary and secondary teeth. For instance, a generally non-circular cross-section might be defined, or the secondary teeth might extend radially inward a greater or lesser extent than the primary teeth, such that the inner surface of the stator core includes recessed regions alternating with projected regions.

Preferably, as best shown in FIG. 4, the inner surface 72 of the stator core 40 is adjacent the radial margin 38 of the rotor 12 such that only a very small gap 74 is formed therebetween.

As shown schematically in FIG. 3, it is preferred that each of the primary teeth 44 is wound with wire 76 so that a coil 78 is formed thereabout. More particularly, a coil 78 is wound about each primary tooth arm 50 such that the coils 78 are formed in the slots 48 and at least substantially circumscribe the respective primary tooth arms 50.

The winding is preferably a single tooth winding, resulting in isolated coils 78 and advantageously resulting in shorter end turns and lower line losses. However, such a winding pattern may result in increased inductance relative to that for a conventional winding pattern, resulting in a higher volt-amperes requirement (or a lower motor or generator power factor). The winding pattern may also impact the power module (require higher current).

The wire 76 preferably comprises aluminum, although copper or any one or more of a variety of electrically conductive materials may be used without departing from the scope of the present invention.

As shown schematically in FIG. 3, the wire 76 is preferably wound in such a manner that the motor or generator is a three-phase motor or generator having phases designated A, B, and C. More particularly, the wire 76 preferably forms a pair of A-phase coils 78a, a pair of B-phase coils 78b, and a pair of C-phase coils 78c.

Preferably, the three phases are each separated by one hundred twenty (120) electrical degrees. However, it is within the scope of some aspects of the present invention for a non-three-phase winding pattern to be utilized.

Preferably, the secondary teeth 46 are devoid of windings. It is permissible according to some aspects of the present invention, however, for the secondary teeth to be wound.

In a preferred embodiment, the secondary teeth 46 contribute to the reduction of cogging torques.

As best shown in FIG. 4, each primary tooth 44 presents a primary arm width or thickness w₁, preferably measured in a generally tangential direction, and a primary crown span or extent Θ₁, preferably measured generally arcuately. Likewise, each secondary tooth 46 presents a secondary arm width or thickness w₂, preferably measured in a generally tangential direction, and a secondary crown span or extent Θ₂, preferably measured generally arcuately.

Preferably, the primary teeth 44 are at least substantially uniform such that the primary arm widths w₁ are at least substantially equal and the primary crown extents Θ₁ are at least substantially equal. Likewise, the secondary teeth 46 are preferably at least substantially uniform such that the secondary arm widths w₂ are at least substantially equal and the secondary crown extents Θ₂ are at least substantially equal. It is permissible according to some aspects of the present invention, however, for variable widths and/or spans to be present within the primary teeth and/or the secondary teeth.

In a preferred embodiment, the primary arm width w₁ is greater than the secondary arm width w₂. More particularly, the ratio of the primary arm width w₁ to the secondary arm width w₂ is preferably between 2.0:1 and 2.5:1, inclusive. Most preferably, the ratio of the primary arm width w₁ to the secondary arm width w₂ is approximately 2.3:1. For instance, in a preferred embodiment, the primary arm width w₁ is 0.276 inches, while the secondary arm width w₂ is 0.120 inches. The ratio may suitably vary somewhat from the preferred range presented above, however, without departing from the scope of some aspects of the present invention.

Preferably, the widths w₁ and w₂ are average widths. In the illustrated embodiments, in which the arms have a constant width, any measured width is an average width. However, certain variations in arm shape for which the widths vary along the respective radial axes of the arms fall within the scope of the present invention. For instance, although the primary and secondary arms 50 and 54, respectively, may suitably be straight, symmetrical, and of constant width, as illustrated, it is permissible for some or all of the arms to be tapered. The portion of the arm near the yoke might have a greater width than the portion of the arm near the crown, for instance. In such a case or in other cases including deviations from the preferred configuration described above and illustrated in FIGS. 2-4, an average width may be used in calculating the widths and the width ratio discussed above.

Each primary crown span Θ₁ is preferably approximately one hundred sixty (160) to two hundred (200) electrical degrees. Most preferably, each primary crown span Θ₁ is approximately one hundred eighty (180) electrical degrees.

Preferably, as shown in FIGS. 3 and 4, the stator core 40 includes six (6) primary teeth 44 and six (6) secondary teeth 46, such that a total of twelve (12) teeth are provided. The twelve (12) teeth preferably define twelve (12) slots 48. However, it is permissible according to some aspects of the present invention for more or fewer of each type of tooth to be provided.

Preferably, the rotor 12 defines eight (8) poles, such that the motor or generator 10 is a twelve slot, eight pole (12 slot/8 pole) motor or generator. In such a slot/pole configuration, the preferred primary crown span Θ₁ of approximately one hundred sixty (160) to two hundred (200) electrical degrees corresponds to a primary crown span Θ₁ of forty (40) to fifty (50) mechanical degrees. Likewise, the most preferred primary crown span Θ₁ of one hundred eighty (180) electrical degrees corresponds to a primary crown span Θ₁ of forty-five (45) mechanical degrees.

Although a twelve slot, eight pole (12 slot/8 pole) configuration is preferred, it is permissible according to some aspects of the present invention for the motor or generator 10 to have an alternative configuration. For instance, any slot/pole combination having a three slot to two pole (3 slot/2 pole) ratio, wherein an even number of slots is provided (such that the number of primary teeth equals the number of secondary teeth) and wherein the number of slots is evenly divisible by the number of phases (three phases in the preferred embodiment) is permissible. For instance, a six slot, four pole (6 slot/4 pole) motor or generator having a primary crown span Θ₁ of one hundred eighty (180) electrical degrees or ninety (90) mechanical degrees might be provided. Likewise, a twenty-four slot, sixteen pole (24 slot/16 pole) motor or generator having a primary crown span Θ₁ of one hundred eighty (180) electrical degrees or twenty-two and one half (22.5) mechanical degrees might be provided without departing from the scope of the present invention. Furthermore, slot/pole combinations other than those meeting the above-described preferred slot/pole ratio and/or slot divisibility requirements are also permissible according to some aspects of the present invention.

Although the above description presents features of preferred embodiments of the present invention, other preferred embodiments may also be created in keeping with the principles of the invention. Furthermore, these other preferred embodiments may in some instances be realized through a combination of features compatible for use together despite having been presented independently as part of separate embodiments in the above description.

The preferred forms of the invention described above are to be used as illustration only and should not be utilized in a limiting sense in interpreting the scope of the present invention. Obvious modifications to the exemplary embodiments, as hereinabove set forth, could be readily made by those skilled in the art without departing from the spirit of the present invention.

The inventor hereby states his intent to rely on the Doctrine of Equivalents to determine and assess the reasonably fair scope of the present invention.

What is claimed is:

1. An electric motor or generator machine comprising:
a rotor rotatable about an axis; and
a stator,
said stator including -
a stator core; and
wiring wound around the stator core,
said core including a plurality of arcuately spaced apart alternating primary teeth and secondary teeth, such that each secondary tooth is spaced between a corresponding pair of primary teeth,
said wiring being wound about the primary teeth to form a plurality of coils,
said plurality of coils including an A-phase coil, a B-phase coil, and a C-phase coil,
each of said primary teeth including a generally radially extending primary arm and a generally arcuately extending primary crown,
each of said primary crowns spanning 160 to 200 electrical degrees.

2. The machine as claimed in claim 1,
said rotor defining a plurality of poles,
said teeth cooperatively defining a plurality of slots therebetween, wherein the ratio of slots to poles is 3:2.

3. The machine as claimed in claim 1,
said stator core including six primary teeth and six secondary teeth cooperatively defining twelve slots therebetween,
said rotor defining eight poles,
each of said primary crowns spanning 40 to 50 mechanical degrees.

4. The machine as claimed in claim 3,
said plurality of coils comprising a pair of A-phase coils, a pair of B-phase coils, and a pair of C-phase coils,
each of said A-phase coils, B-phase coils, and C-phase coils being wound about a corresponding one of said primary teeth.

5. The machine as claimed in claim 1,
each of said primary crowns spanning approximately 180 electrical degrees,
each of said primary crowns spanning approximately 45 mechanical degrees.

6. The machine as claimed in claim 1,
said stator at least substantially circumscribing said rotor, with each primary arm extending radially inward to position the primary crown adjacent the rotor.

7. The machine as claimed in claim 1,
said rotor including a rotor core and a plurality of arcuately spaced apart permanent magnets,
said magnets at least in part defining a radially innermost margin of the rotor or a radially outermost margin of the rotor.

8. The machine as claimed in claim 7,
said rotor core including a plurality of arcuately spaced apart, generally radially extending rotor teeth,
each of said rotor teeth including a generally radially extending rotor tooth arm and a generally arcuately extending rotor tooth crown,
said rotor teeth being alternately arcuately arranged with said magnets.

9. The machine as claimed in claim 7,
said rotor core including a plurality of arcuately spaced apart, generally radially extending sensing tabs,
each of said tabs extending between a corresponding pair of said magnets.

10. The machine as claimed in claim 1,
each of said secondary teeth including a generally radially extending secondary arm,
each of said primary arms having a primary arm width in a generally arcuate direction,
each of said secondary arms having a secondary arm width in the generally arcuate direction,
said primary arm width being 2 to 2.5 times greater than said secondary arm width.

11. The machine as claimed in claim 10,
said primary arm width being approximately 2.3 times greater than said secondary arm width.

12. The machine as claimed in claim 10,
each of said primary arm widths and each of said secondary arm widths being at least substantially constant along the radial direction.

13. The machine as claimed in claim 1,
each of said primary teeth and each of said secondary teeth being generally symmetrical about respective radial axes.

14. The machine as claimed in claim 1,
each of said primary arms and each of said secondary arms being at least substantially straight.

15. The machine as claimed in claim 10,
each of said primary arm widths and each of said secondary arm widths being an average width along the radial direction.

16. The machine as claimed in claim 1,
each of said primary crowns including a pair of crown sections that project in generally opposite, generally arcuate directions from an end of the corresponding primary arm,
each of said primary teeth being associated with one of said pairs of crown sections,
each crown section of each pair of crown sections being of substantially equal length.

17. The machine as claimed in claim 1,
said primary teeth being evenly arcuately spaced apart,
said secondary teeth being evenly arcuately spaced apart.

18. The machine as claimed in claim 1,
said wiring being wound in a single tooth winding pattern.

19. The machine as claimed in claim 1,
said secondary teeth being devoid of windings.

20. The machine as claimed in claim 1,
each of said secondary teeth having a generally arcuately extending secondary crown.
